(19) United States
(12) Patent Application Publication
(10) Pub. No.: US 2016/0363752 A1
(43) Pub. Date: Dec. 15, 2016

(54) SHEET ILLUMINATION MICROSCOPE AND ILLUMINATION METHOD FOR SHEET ILLUMINATION MICROSCOPE

(71) Applicant: OLYMPUS CORPORATION, Tokyo (JP)

(72) Inventors: Masaru MIZUNAKA, Tokyo (JP); Yoshihiro SHIMADA, Sagamihara (JP)

(73) Assignee: OLYMPUS CORPORATION, Tokyo (JP)

(21) Appl. No.: 15/173,423

(22) Filed: Jun. 3, 2016

(30) Foreign Application Priority Data
Jun. 9, 2015 (JP) 2015-117028

(51) Int. Cl. G02B 21/08

(52) U.S. Cl. CPC G02B 21/08

(57) ABSTRACT

A sheet illumination microscope includes an observation optical system and an illumination optical system configured to illuminate a sample from a direction perpendicular to an observation optical axis of the observation optical system. The illumination optical system includes a first optical system configured to emit a flux that has a prescribed sectional shape and that does not have a light intensity distribution within a prescribed range from the center of gravity position of the sectional shape, and also includes a second optical system. The second optical system includes a deflector configured to deflect, toward the observation optical axis, light entering from a direction parallel to the observation optical axis. The second optical system is configured to form, from the flux, a plurality of light sheets that are parallel to a plane perpendicular to the observation optical axis and that have different traveling directions.

### CROSS REFERENCE TO RELATED APPLICATIONS

This application is based upon and claims the benefit of priority from prior Japanese Patent Application No. 2015-117028, filed Jun. 9, 2015, the entire contents of which are incorporated herein by this reference.

### BACKGROUND OF THE INVENTION

Field of the Invention

The present invention relates to a technique of a sheet illumination microscope and an illumination method therefor.

Description of the Related Art

In the field of fluorescence microscopes, a technique is known in which a sample is irradiated with light from a direction perpendicular to the optical axis of the observation optical system (referred to as an observation optical axis hereinafter). This technique has advantages including the realization of high resolution in the z directions, which results in reduced damage to the sample, and has been attracting attention in recent years.

Japanese Laid-open Patent Publication No. 2006-030991 for example describes a technique in which an illumination line is formed in a sample and a scanner moves the illumination line so as to generate a light sheet that is perpendicular to the observation optical axis.

### SUMMARY OF THE INVENTION

An aspect of the present invention provides a sheet illumination microscope including: an observation optical system configured to form an image of a sample by utilizing light from the sample; and an illumination optical system configured to illuminate the sample from a direction perpendicular to an observation optical axis of the observation optical system, wherein the illumination optical system includes: a first optical system configured to emit a flux that has a prescribed sectional shape and that does not have a light intensity distribution within a prescribed range from a center of gravity position of the sectional shape; and a second optical system that includes a deflector configured to deflect, toward the observation optical axis, light entering from a direction parallel to the observation optical axis and that is configured to form, from the flux, a plurality of light sheets that are parallel to a plane perpendicular to the observation optical axis and that have different traveling directions.

Another aspect of the present invention provides an illumination method for a sheet illumination microscope that illuminate a sample from a direction perpendicular to an observation optical axis of an observation optical system, the illumination method including: emitting a flux that has a prescribed sectional shape and that does not have a light intensity distribution within a prescribed range from a center of gravity position of the sectional shape; and deflecting light traveling in a direction parallel to the observation optical axis so as to form, from the flux, a plurality of light sheets that are parallel to a plane perpendicular to the observation optical axis and that have different traveling directions.

### BRIEF DESCRIPTION OF THE DRAWINGS

The present invention will be more apparent from the following detailed description when the accompanying drawings are referenced.

FIG. 1 shows a configuration of a sheet illumination microscope 1 according to an embodiment of the present invention;

FIG. 2 shows an example of a sectional shape of a parallel flux emitted from a first optical system 14;

FIG. 3 shows operations of a second optical system 15;

FIG. 4 shows an example of a light sheet formed by an illumination optical system 10 seen from the direction of observation optical axis AX;

FIG. 5 shows a configuration of a sheet illumination microscope 2 according to another embodiment of the present invention;

FIG. 6 shows a configuration of a sheet illumination microscope 3 according to still another embodiment of the present invention;

FIG. 7 shows a configuration of a sheet illumination microscope 4 according to still another embodiment of the present invention;

FIG. 8 shows a configuration of a sheet illumination microscope 5 according to still another embodiment of the present invention;

FIG. 9A shows a configuration of an illumination optical system 100 according to example 1, and is a view showing a section parallel to observation optical axis AX of the illumination optical system 100;

FIG. 9B shows a configuration of the illumination optical system 100 according to example 1, and is a plane view of a second optical system 120 seen from the direction of observation optical axis AX;

FIG. 10 shows a section parallel to observation optical axis AX of an illumination optical system 101, which is a variation example of a first optical system 110;

FIG. 11 shows a section parallel to observation optical axis AX of an illumination optical system 102, which is another variation example of the first optical system 110;

FIG. 12A is a plane view showing a second optical system 150, which is a variation example of the second optical system 120, seen from the direction of observation optical axis AX;

FIG. 12B is a plane view showing a second optical system 160, which is another variation example of the second optical system 120, seen from the direction of observation optical axis AX;

FIG. 13A shows a configuration of an illumination optical system 200 according to example 2, and is a view showing a section parallel to observation optical axis AX of the illumination optical system 200;

FIG. 13B shows a configuration of the illumination optical system 200 according to example 2, and is a plane view showing a prism 230 seen from the direction of observation optical axis AX;

FIG. 14A shows a configuration of an illumination optical system 300 according to example 3, and is a view showing a section parallel to observation optical axis AX of the illumination optical system 300;

FIG. 14B shows a configuration of the illumination optical system 300 according to example 3, and is a plane view showing a second optical system 330 seen from the direction of observation optical axis AX;

FIG. 15A is shows a configuration of an illumination optical system 400 according to example 4, and is a view showing a section parallel to observation optical axis AX of the illumination optical system 400;

FIG. 15B shows a configuration of the illumination optical system 400 according to example 4, and is a plane view showing a second optical system 420 seen from observation optical axis AX;

FIG. 16 shows a configuration of a second optical system 520, which is a variation example of the second optical system 420;

FIG. 17 shows a configuration of a second optical system 620, which is another variation example of the second optical system 420;

FIG. 18A through FIG. 18D show a configuration of an illumination optical system 700 according to example 5;

FIG. 18A is a view showing a section parallel to observation optical axis AX of the illumination optical system 700, FIG. 18B is a perspective view of the first optical system 710, and FIG. 18C and FIG. 18D are plane views showing the second optical system 720 before and after the revolution of the illumination optical system 700 seen from the direction of observation optical axis AX;

FIG. 19A shows a configuration of an illumination optical system 800, which is a variation example of the illumination optical system 700, and is a view showing a section parallel to observation optical axis AX of the illumination optical system 800; and

FIG. 19B shows a configuration of the illumination optical system 800, which is a variation example of the illumination optical system 700, and is a perspective view of a first optical system 810.

### DESCRIPTION OF THE EMBODIMENTS

Using a scanner for the formation of a light sheet as described in Japanese Laid-open Patent Publication No. 2006-030991 results in a higher level of complexity of the device and a longer time taken for scanning the sample and thus for obtaining images, which is problematic. In view of this, there is a demand for a technique that realizes the illumination of a wide area of a sample at a single time by using a light sheet without using a scanner so as to obtain images in a short period of time.

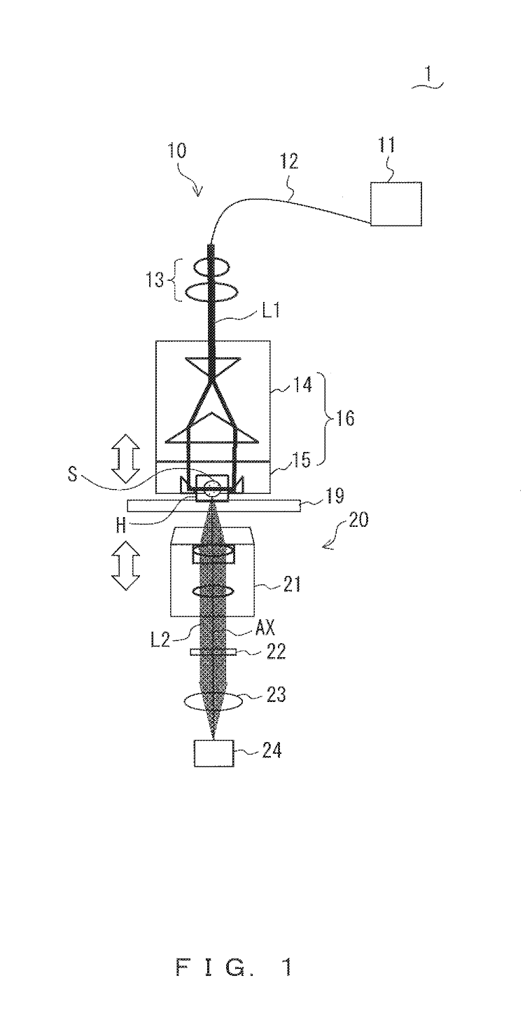

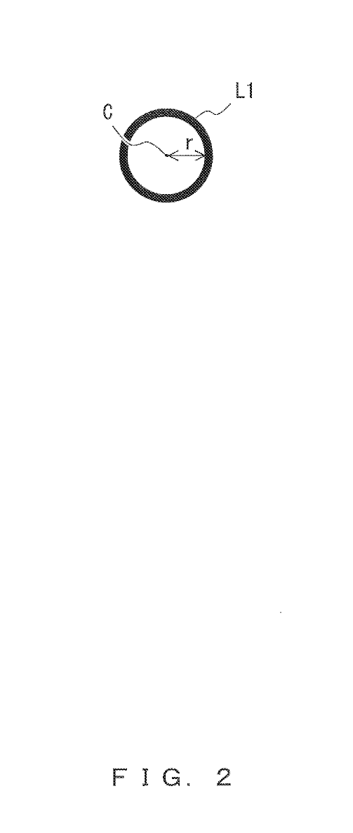

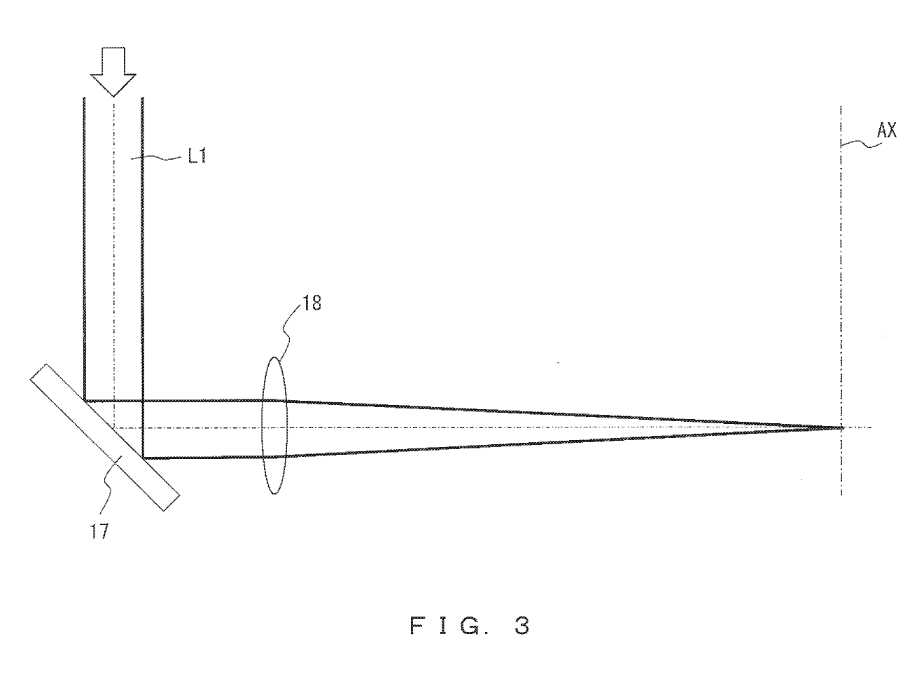

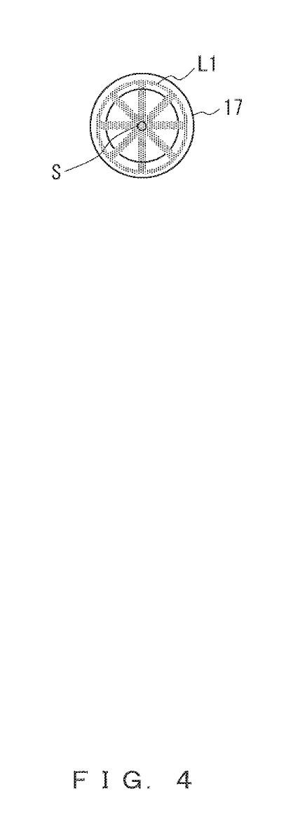

FIG. 1 shows a configuration of a sheet illumination microscope 1 according to an embodiment of the present invention. FIG. 2 shows an example of the sectional shape of a parallel flux emitted from a first optical system 14. FIG. 3 explains operations of a second optical system 15. FIG. 4 shows an example of a light sheet formed by an illumination optical system 10, seen from the direction of observation optical axis AX.

The sheet illumination microscope 1 shown in FIG. 1 is an inverted microscope including the illumination optical system 10 and an observation optical system 20 that are disposed face to face having a stage 19 between them. The sheet illumination microscope 1 is for example a fluorescence microscope that detects fluorescence from sample S, which is a biological sample. Note that sample S is held by a holder H that fixes sample S at a prescribed position.

The illumination optical system 10 includes a laser light source 11, an optical fiber 12, a beam expander 13, and an illumination module 16 having a first optical system 14 and a second optical system 15. The illumination optical system 10 is configured to illuminate sample S from the direction perpendicular to observation optical axis AX of the observation optical system 20.

Laser light L1 emitted from the laser light source 11 enters the beam expander 13 via the optical fiber 12, is converted by the beam expander 13 into a parallel flux having a prescribed flux diameter, and enters the first optical system 14.

The first optical system 14 is configured to emit a parallel flux that has a prescribed sectional shape and that does not have a light intensity distribution within a prescribed range from center of gravity C of that sectional shape. It is intended with this configuration that when the first optical system 14 has guided, along observation optical axis AX, the parallel flux formed by the first optical system 14 to the same plane as sample S, sample S be positioned within the above prescribed range and be surrounded by the parallel flux. In other words, the prescribed sectional shape is such a shape as to make sample S be surrounded by the parallel flux.

The first optical system 14 converts the parallel flux that entered from the beam expander 13 into for example a parallel flux in a ring shape with the inner diameter of 2 r having center of gravity C at its center, as shown in FIG. 2, and emits the flux to the second optical system 15. It is desirable that the first optical system 14 emit the parallel flux to the second optical system 15 in such a manner that center of gravity C nearly coincides with observation optical axis AX of the observation optical system 20.

The second optical system 15 is configured to form, from the parallel flux that entered from the direction of observation optical axis AX (i.e. the direction parallel to observation optical axis AX), a plurality of light sheets that are parallel to a plane perpendicular to observation optical axis AX and that have different travelling directions. Each of the light sheets formed by the second optical system 15 is a nearly parallel flux on a plane perpendicular to observation optical axis AX. In other words, each of the light sheets has light rays that are parallel to each other on a sectional plane perpendicular to observation optical axis AX. Also, each of the plurality of light sheets is a convergent flux on a plane including observation optical axis AX and the optical axis of the illumination light of that light sheet. In other words, each light sheet has light rays that are not parallel to each other on a sectional plane, including observation optical axis AX and the optical axis of the illumination light of that light sheet. Note that the optical axis of the illumination light of a light sheet is an optical axis with respect to the emission side of the second optical system and exists in plural. Also, when the optical system has a direction in which there is no refractive power, it is assumed that the optical axis of the illumination light in that direction passes through the center position of the flux.

As shown in for example FIG. 3, the second optical system 15 has a deflection member 17 and a condensing member 18. Herein, explanations will be given only for the plane including observation optical axis AX and the optical axis of the illumination light. The deflection member 17 is a deflector that deflects light having been emitted from the first optical system 14 and having entered from the direction parallel to observation optical axis AX, in the direction that is perpendicular to observation optical axis AX and that is toward observation optical axis AX. The condensing member 18 is a condenser that has a positive refractive power on a plane including observation optical axis AX and the optical axis of the illumination light and that has the focal position at the intersection between observation optical axis AX and the optical axis of the illumination light. In the example shown in FIG. 3, the optical axis of the illumination light is the optical axis of the condensing member 18.

In order to form a plurality of light sheets on the same plane, it is desirable that the deflection member 17 have a shape that is in accordance with the sectional shape of the parallel flux from the first optical system 14 so that the entire parallel flux enters the deflection member 17 at roughly the same height. When for example a ring-shaped parallel flux as shown in FIG. 2 enters, the deflection member 17 may have a ring shape as seen from the direction of observation optical axis AX as shown in FIG. 4. In such a case, the second optical system 15 converts a parallel flux emitted from the first optical system 14 into for example eight light sheets travelling in eight directions that are orthogonal to observation optical axis AX as shown in FIG. 4, and sample S is irradiated with them.

The numerical apertures of the light sheets depend upon the diameter of the parallel flux emitted from the beam expander 13 as well as upon the power of the condensing member 18. Accordingly, it is desirable for the beam expander 13 to enlarge the flux diameter so that the light sheets can have desired numerical apertures. Also, the beam expander 13 may be configured as a zoom optical system that can change the flux diameter continuously.

The observation optical system 20 includes an objective 21, a barrier filter 22, an imaging lens 23 and a photodetector 24. The observation optical system 20 is configured to form an image of sample S by utilizing fluorescence L2, arriving from sample S, with which the optical sheets were irradiated. The objective 21 and the imaging lens 23 condense fluorescence L2 arriving from sample S to the photodetector 24 so as to form an image of sample S, and an image pickup device, such as a CCD camera etc., that has the photodetector 24 picks up the image of sample S so as to obtain an image of sample S. The barrier filter 22 has a function of shielding laser light that enters together with fluorescence L2.

In the sheet illumination microscope 1 configured as above, the first optical system 14 forms a parallel flux not having a light intensity distribution within a prescribed range from center of gravity C of the sectional shape, and thereby makes laser light L1 enter a space around sample S from the direction of observation optical axis AX. This makes it possible for laser light L1 to surround sample S. Thereby, the second optical system 15 deflects laser light L1 to observation optical axis AX so as to form light sheets so that sample S can be irradiated with a plurality of light sheets having different traveling directions without the use of a scanner. In the above, an example of the light flux emitted from the first optical system 14 is parallel flux. But the light flux emitted from the first optical system 14 is not limited to parallel flux. As long as the second optical system 15 can form a light sheet, the light flux emitted from the first optical system 14 may be a light flux such as a convergent flux or a divergent flux.

Accordingly, the sheet illumination microscope 1 can illuminate a wide area of sample S at a time with a simple configuration and can obtain an image of sample S in a period of time shorter than in a case of using a scanner. Also, irradiation of sample S from a plurality of different directions can greatly reduce cases in which shadows in sample S occur. This realizes the obtainment of a sectional image of sample S that does not involve a shadow.

Conventional sheet illumination microscopes, which form light sheets by using a scanner, need to make the position of the scanner coincide with the pupil position or the conjugated position of the optical system. Because of this necessity, it is desirable that sample S instead of the optical system be moved in the Z axial directions so as to form light sheets at different Z positions on sample S (positions in the direction of observation optical axis AX) in a conventional sheet illumination microscope. By contrast, the sheet illumination microscope 1 forms light sheets without using a scanner, being free from the positional limitations caused by scanners. A case is assumed where moving of sample S easily causes vibrations in sample S, making it difficult to form light sheets at prescribed positions on sample S. In such a case, the sheet illumination microscope 1 can form light sheets at different z positions on sample S by using a method in which the illumination module 16 and the objective 21 are moved in the direction of observation optical axis AX in a coordinated manner. Accordingly, the sheet illumination microscope 1 allows for appropriate selection of a method of moving the relative positions of light sheets with respect to sample S in the direction of observation optical axis AX, which leads to fewer vibrations in sample S. Note that the illumination module 16 may be linked to for example a mechanism that moves the objective 21 in the direction of observation optical axis AX or may be configured to mechanically coordinate with the movement of the objective 21.

Also, in the sheet illumination microscope 1, first optical system 14 and the second optical system 15 are configured as a single illumination module 16. Accordingly, by preparing a plurality of modules of different specifications in advance and switching the modules in accordance with necessity, light sheets of different specifications can easily be formed. Also, modules of different specifications may be for example modules that form ring-shaped parallel fluxes of different sizes. It is also possible to use different modules in accordance with the size of sample S. Note that it is also possible to employ a configuration in which the first optical system 14 and the second optical system 15 are attachable to and detachable from each other.

FIG. 2 shows a ring shape as an example of a sectional shape not having a light intensity distribution within a prescribed range from center of gravity position C, but the sectional shape of the parallel flux is not limited to a ring shape. For example, it may be a polygonal ring shape such as a rectangular ring shape or maybe an elliptic ring shape. Also, when the sectional shape can surround sample S to some extent, it is possible to form a plurality of light sheets having different traveling directions so as to irradiate sample S with them. Therefore, the sectional shape does not always have to be a looped shape. For example, a parallel flux may be a group of a plurality of partial fluxes arranged in a circular shape or a polygonal shape.

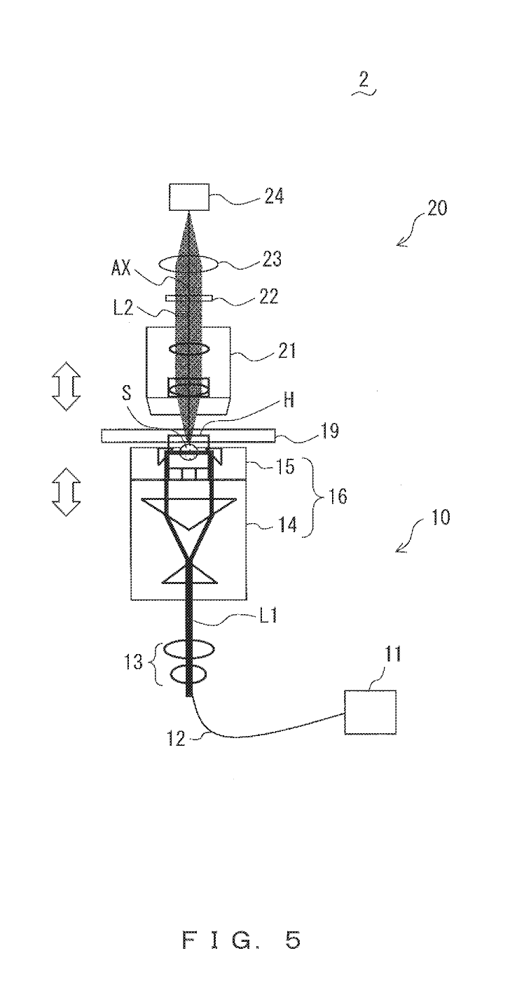

FIG. 1 exemplifies an inverted microscope, but the sheet illumination microscope is not limited to being an inverted microscope but may also be an upright microscope. FIG. 5 exemplifies a configuration of a sheet illumination microscope 2, which is an upright microscope. The sheet illumination microscope 2 includes the illumination optical system 10 below sample S and includes the observation optical system 20 above sample S, which is a different point from the sheet illumination microscope 1. The sheet illumination microscope 2 can also bring about effects similar to those brought about by the sheet illumination microscope 1.

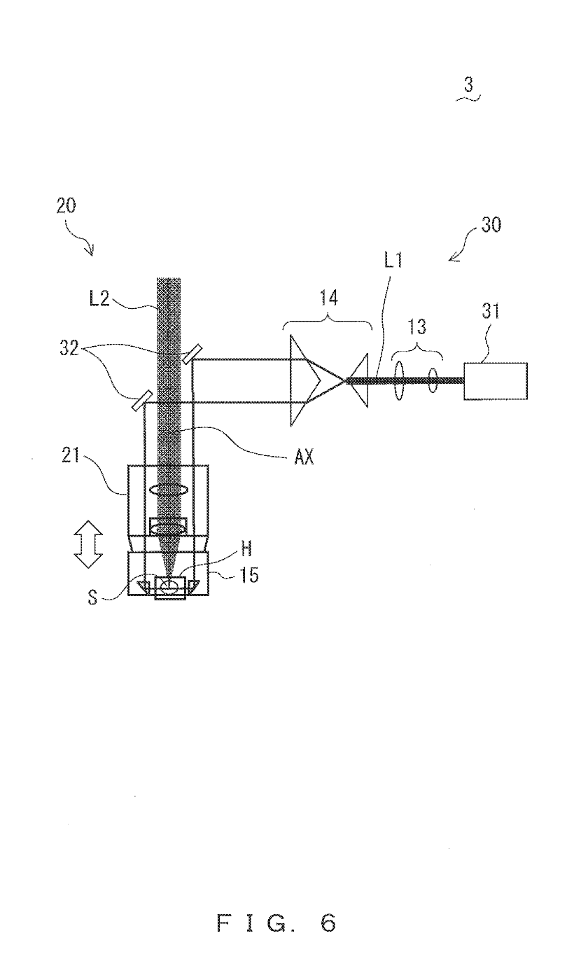

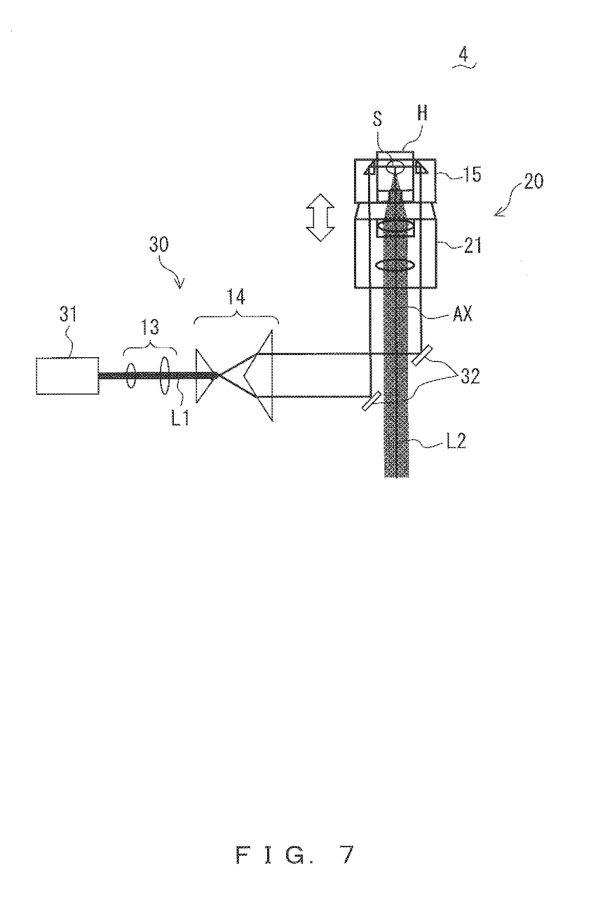

FIG. 1 and FIG. 5 show an example in which the illumination optical system 10 and the observation optical system 20 face each other having sample S between them, but the illumination optical system and the observation optical system may be provided on the same side of sample S. FIG. 6 and FIG. 7 show configurations of sheet illumination microscopes in which an illumination optical system 30 and the observation optical system 20 are provided on the same side of sample S. FIG. 6 shows a configuration of a sheet illumination microscope 3, which is an upright microscope, and FIG. 7 shows a configuration of a sheet illumination microscope 4, which is an inverted microscope. The illumination optical system 30 includes a laser light source 31 instead of the laser light source 11 and the optical fiber 12 and further includes a mirror 32 having an opening through which fluorescence L2 passes, which are different points from the illumination optical system 10. The sheet illumination microscope 3 and the sheet illumination microscope 4 as well can bring about effects similar to those brought about by the sheet illumination microscope 1. Also, in the sheet illumination microscope 3 and the sheet illumination microscope 4, by attaching the second optical system 15 to the objective 21, the moving of the second optical system 15 and the moving of the objective 21 in the direction of observation optical axis AX can reliably be brought into a coordinated state.

FIG. 6 and FIG. 7 show an example in which laser light L1 enters the second optical system 15 after passing through the objective 21 (for example, the dark-field optical path in an incident-light dark-field objective), but laser light L1 may enter second optical system 15 after travelling outside the objective 21.

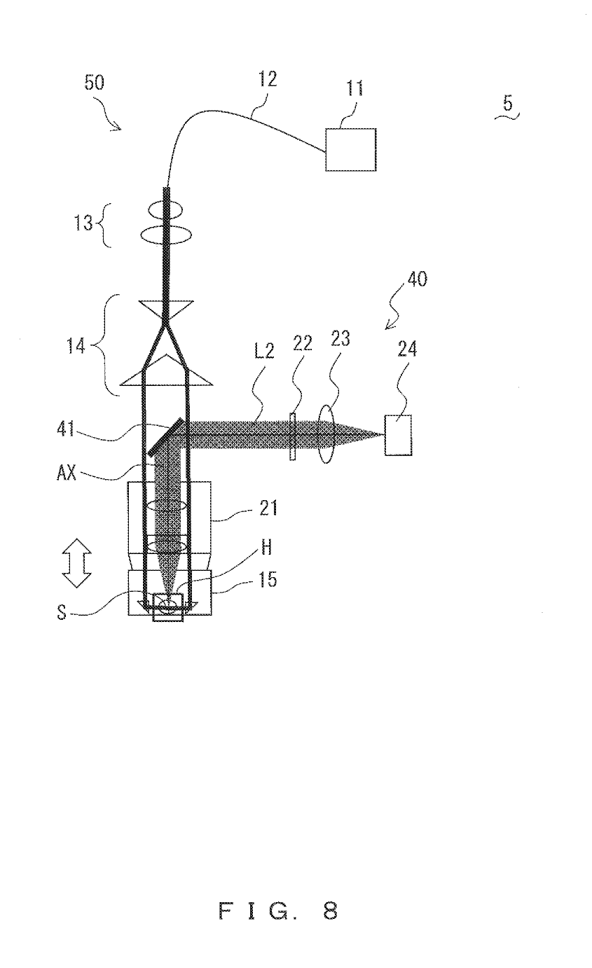

Also, FIG. 6 and FIG. 7 show a configuration in which the mirror 32 reflects laser light L1 so as to guide it in the direction of observation optical axis AX, but a mirror 41 may reflect fluorescence L2 so as to guide it to the photodetector 24. FIG. 8 shows a configuration of a sheet illumination microscope 5 having an illumination optical system 50 and an observation optical system 40. The illumination optical system 50 is different from the illumination optical system 10 in that the illumination optical system 50 has the first optical system 14 and the second optical system 15 separated from each other and in that the second optical system 15 is configured to be attachable to and detachable from the objective 21. The observation optical system 40 is different from the observation optical system 20 in that the observation optical system 40 has the mirror 41 and also has the barrier filter 22, the imaging lens 23 and the photodetector 24 on the reflection optical path of the mirror 41. The sheet illumination microscope 5 as well can bring about effects similar to those brought about by the sheet illumination microscope 1. Also, similarly to the sheet illumination microscope 3 and the sheet illumination microscope 4, the sheet illumination microscope 5 can reliably bring the moving of the second optical system 15 and the moving of the objective 21 in the direction of observation optical axis AX to a coordinated state by having the second optical system 15 attached to the objective 21.

Note that it is possible to employ a configuration in which a dichroic mirror is used for the mirror 41 so as to omit the barrier filter 22. It is also possible to use a dichroic mirror having a wavelength characteristic that transmits excitation light and reflects fluorescence so as to omit the barrier filter 22.

Hereinafter, by referring to respective examples of the present invention, explanations will be given for specific configurations of an illumination optical system that illuminates sample S from the direction perpendicular to observation optical axis AX of the observation optical system.

### Example 1

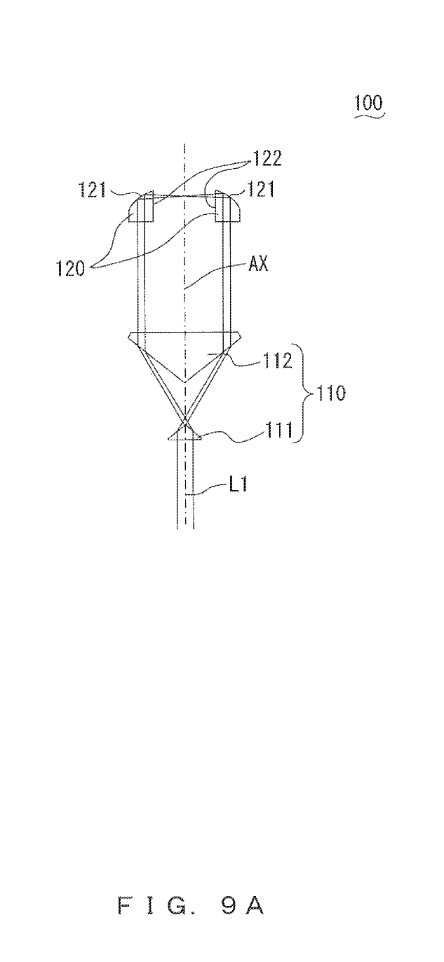

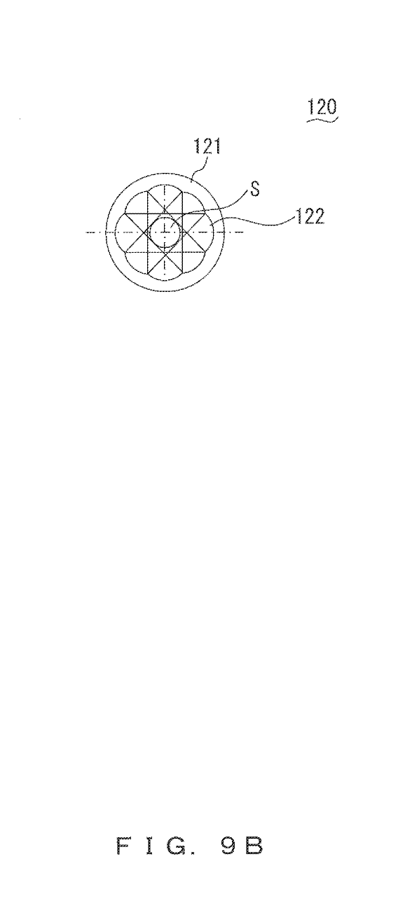

A sheet illumination microscope according to the present example is similar to the sheet illumination microscope 1 except that it has an illumination optical system 100 instead of the illumination optical system 10. FIG. 9A and FIG. 9B show a configuration of the illumination optical system 100 according to the present example. FIG. 9A shows a section parallel to observation optical axis AX of the illumination optical system 100. FIG. 9B is a plan view showing a second optical system 120 seen from the direction of observation optical axis AX. In FIG. 9A, the laser light source 11, the optical fiber 12 and the beam expander 13 are not shown.

The illumination optical system 100 includes a first optical system 110 that forms a parallel flux having a prescribed sectional shape and a second optical system 120 that forms, from the parallel flux arriving from the first optical system 110, a plurality of light sheets having different traveling directions.

As shown in FIG. 9A, the first optical system 110 includes a pair of axicon lenses (an axicon lens 111 and an axicon lens 112) having their vertexes face each other. The axicon lens 111 and the axicon lens 112 are disposed along the direction of observation optical axis AX in such a manner that the respective vertexes are on observation optical axis AX.

As shown in FIG. 9A and FIG. 9B, the second optical system 120 is a prism having a reflection surface 121 for reflecting light and a refraction surface 122 for refracting light. The reflection surface 121 is in a three-dimensional shape that is a result of removing the central portion (portion including the axis of symmetry) of the paraboloid of revolution having its focal point in the vicinity of observation optical axis AX. In other words, the reflection surface 121 has a shape that overlaps the paraboloid of revolution. The reflection surface 121 is circular on a section perpendicular to observation optical axis AX and is parabolic on a section parallel to observation optical axis AX. However, the outline of the prism seen from the direction of observation optical axis AX is not limited to a circle as shown in FIG. 9B, and may be for example a polygon. The refraction surface 122 is a lens surface array made of eight connected concave surfaces. The refraction surface 122 has a shape made of eight connected arcs on a section perpendicular to observation optical axis AX and is linear on a section parallel to observation optical axis AX.

In the illumination optical system 100 having the above configuration, laser light L1 with a prescribed flux diameter that has entered via the beam expander 13 (FIG. 2) is converted into a ring-shaped parallel flux by the refraction in the first optical system 110 (the axicon lens 111 and the axicon lens 112), and is emitted from the first optical system 110. The parallel flux emitted from the first optical system 110 thereafter enters the second optical system 120 from the direction of observation optical axis AX in a state such that the center of gravity position of its sectional shape (center of the ring) of the parallel flux nearly coincides with observation optical axis AX. The ring-shaped parallel flux having entered the second optical system 120 is deflected by the reflection surface 121, which is a deflector, in the direction that is perpendicular to observation optical axis AX and that is toward observation optical axis AX. Upon this deflection, the parallel flux is converted by the positive power of the reflection surface 121, which is also a condenser, into a convergent flux that converges toward the focal point of the paraboloid of revolution (reflection surface 121). Thereafter, the convergent flux having entered the refraction surface 122 is converted by the negative power that the refraction surface 122, which is also a divergence element, has on its plane perpendicular to observation optical axis AX, into a flux that is parallel when it is seen from the direction of observation optical axis AX. Thereby, a light sheet parallel to a plane perpendicular to observation optical axis AX is formed. Note that the refraction surface 122 consists of eight concave surfaces in the second optical system 120, and accordingly eight light sheets having different traveling directions as shown in FIG. 9B are formed, and sample S is irradiated with them.

The illumination optical system 100 can irradiate sample S with a plurality of light sheets having different travelling directions without using a scanner. Accordingly, a sheet illumination microscope having the illumination optical system 100 makes it possible to illuminate a wide area of sample Sat a single time by using a simple device configuration without a scanner and to obtain an image of sample S in a period of time shorter than in a case when a scanner is used. Further, it is also possible to suppress the occurrence of shadows by illuminating sample S from a plurality of directions even when a portion with a high reflectance such as foam etc. on the sample does not allow the parallel flux to travel further and thus causes striped shadows because the sheet light is a parallel flux when it is seen from the direction of observation optical axis AX. It is also possible to move the positions of the light sheets relative to sample S in the Z axis direction at a high speed without moving sample S so as to obtain a three-dimensional image in a short period of time.

FIG. 9A and FIG. 9B show an example in which the prism functions as a deflector, a condenser and a divergence element, but these functions may be implemented by separate optical elements. For example, the second optical system 120 may include, instead of a prism, a mirror (paraboloid mirror) having the same shape as that of the reflection surface 121 and a concave lens array having the same negative power as that of the refraction surface 122. It is also possible to prepare a plurality of concave lens arrays, each having a different number of concave lens elements, in advance so as to use them while switching them. Thereby, the number of the light sheets can be changed. Note that it is desirable that three or more light sheets be formed.

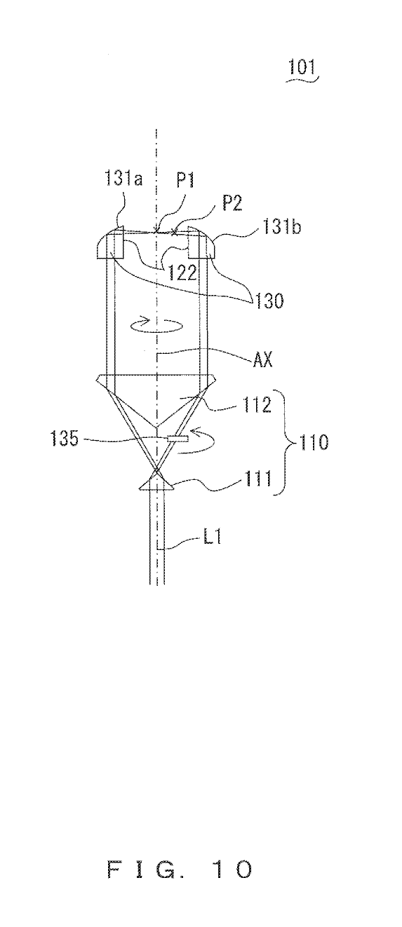

By referring to FIG. 10 through FIG. 12B, variation examples of the illumination optical system 100 of the present example will be explained.

FIG. 10 shows a section that is parallel to observation optical axis AX of an illumination optical system 101, which is a variation example of the illumination optical system 100. The illumination optical system 101 is different from the illumination optical system 100 in that the illumination optical system 101 has a second optical system 130 instead of the second optical system 120, the illumination optical system 101 revolves on observation optical axis AX, and the illumination optical system 101 includes a shutter 135.

The second optical system 130 is configured by using a single prism similarly to the second optical system 120. However, the second optical system 130 is different from the second optical system 120 in that the second optical system 130 has a reflection surface (for example, reflection surfaces 131a and 131b, which are respectively portions of paraboloids, having different shapes) that converges light to a plurality of points. The shutter 135 is a light shielding member for shielding light and is configured to move around observation optical axis AX. The shutter 135 may be arranged at any position without being limited to a position between the axicon lens 111 and the axicon lens 112. The shutter 135 may be arranged for example between the first optical system 110 and the second optical system 130. The shutter 135 may be configured as a divisional shutter instead of being configured to move around observation optical axis AX.

The illumination optical system 101 can use the second optical system 130 so as to make a plurality of light sheets condense light at different positions (such as positions P1 and P2) on the plane perpendicular to observation optical axis AX. Thereby, this realizes uniform illumination of a wider area of sample S. Also, the revolution of the second optical system 130 on observation optical axis AX can change the traveling directions of the eight light sheets. Further, by shielding part of the flux by using the shutter 135, sample S can be prevented from being irradiated with unnecessary light sheets.

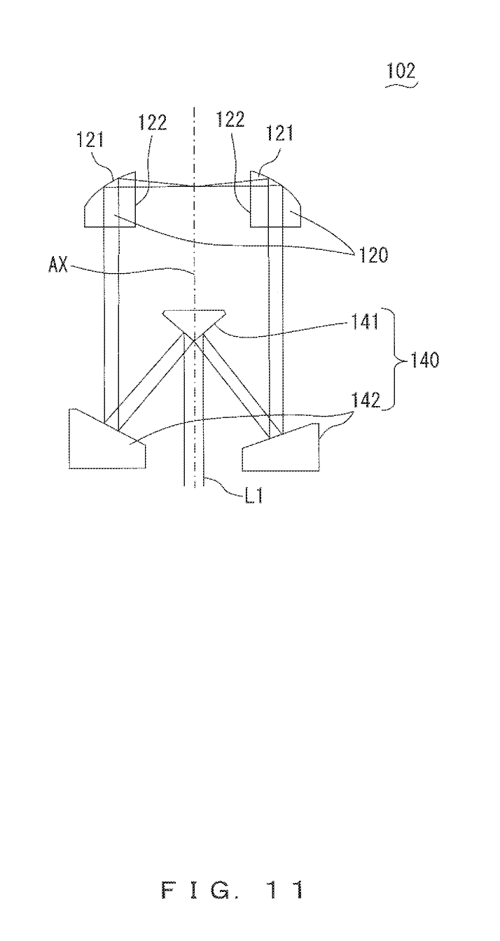

FIG. 11 shows a section parallel to observation optical axis AX of an illumination optical system 102, which is another variation example of the illumination optical system 100. The illumination optical system 102 is different from the illumination optical system 100 in that the illumination optical system 102 has, instead of the first optical system 110 having a pair of axicon lenses, a first optical system 140 having an axicon convex mirror 141 and an axicon concave mirror 142.

In the first optical system 140, reflection of light is utilized to form a ring-shaped parallel flux. This makes it possible for the illumination optical system 102 to prevent an occurrence of chromatic aberration, differently from the illumination optical system 100, which forms a ring-shaped parallel flux by utilizing refraction.

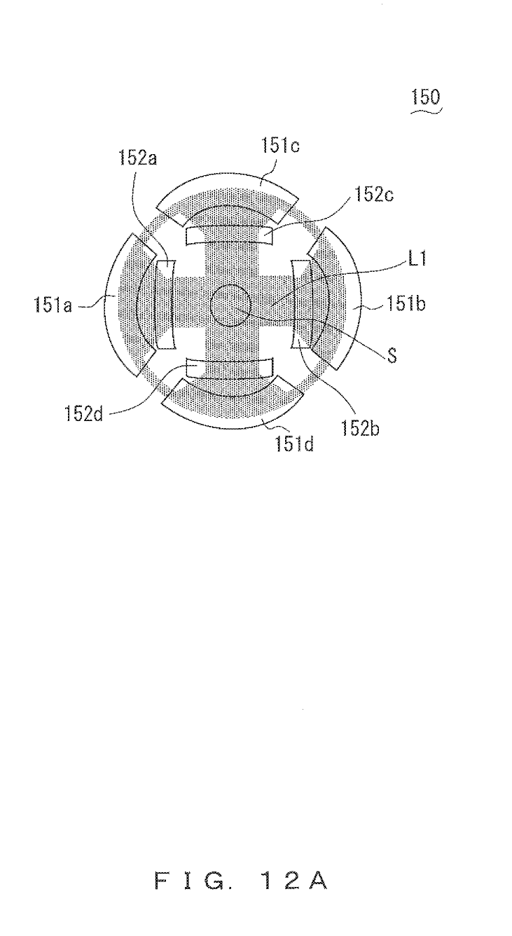

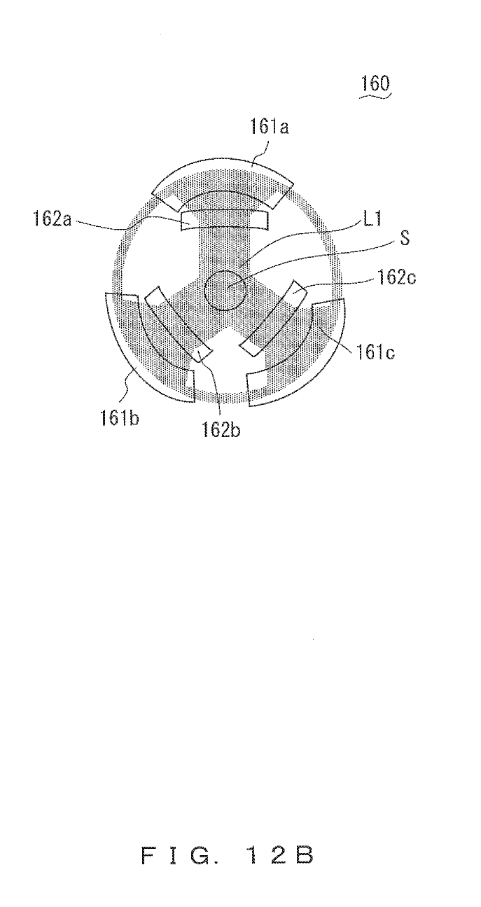

FIG. 12A is a plan view showing a second optical system 150, which is a variation example of the second optical system. 120, seen from the direction of observation optical axis AX. The second optical system 150 has four mirrors (mirrors 151a, 151b, 151c and 151d) and four concave lenses (concave lenses 152a, 152b, 152c and 152d). The four mirrors are arranged in such a manner that their reflection surfaces overlap for one paraboloid of revolution. The four concave lenses are concave cylindrical lenses having a negative power on the plane perpendicular to observation optical axis AX.

In the second optical system 150, the concave lenses convert the flux converged by the mirrors into light sheets parallel to a plane perpendicular to observation optical axis AX. This forms four light sheets travelling from the positions of the four concave lenses to the optical axis (optical axis of the illumination light) of the four concave lenses. Note that the second optical system 150 consists of four mirrors and four concave lenses, making it possible for the second optical system 150 to be used in combination with an existing optical element.

FIG. 12B is a plan view showing a second optical system 160, which is still another variation example, seen from the direction of observation optical axis AX. The second optical system 160 has three mirrors (mirrors 161a, 161b and 161c) and three concave lenses (concave lenses 162a, 162b and 162c). The three mirrors are arranged in such a manner that their reflection surfaces overlap for one paraboloid of revolution. The three concave lenses are concave cylindrical lenses having a negative power on the plane perpendicular to observation optical axis AX.

In the second optical system 160, the concave lenses convert the flux converged by the mirrors into light sheets parallel to a plane perpendicular to observation optical axis AX. This forms three light sheets travelling from the positions of the three concave lenses to the optical axis (optical axis of the illumination light) of the three concave lenses. Note that the second optical system 160 consists of three mirrors and three concave lenses, making it possible for the second optical system 160 to be used in combination with an existing optical element.

### Example 2

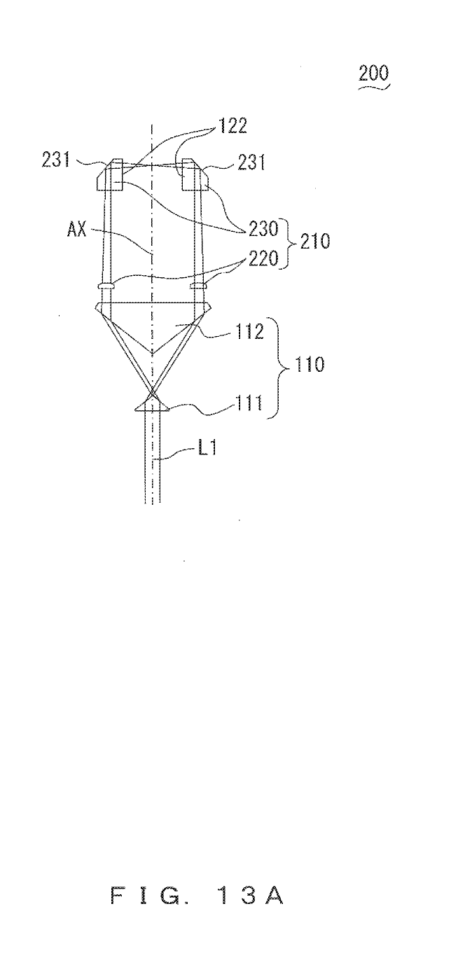

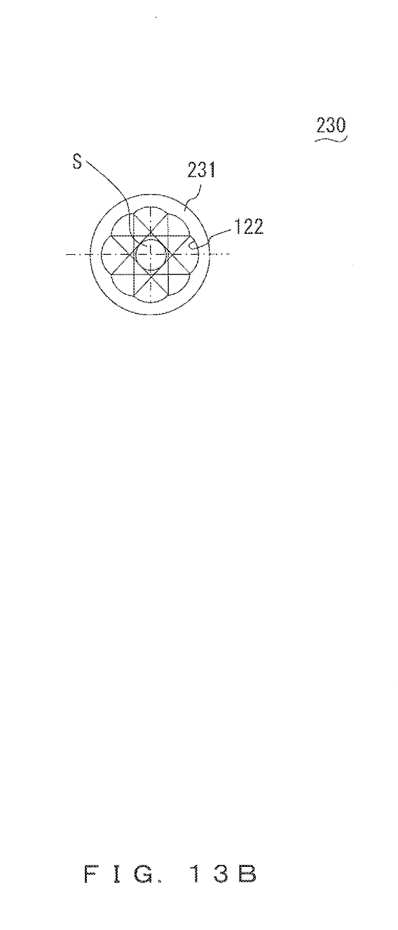

The sheet illumination microscope according to the present example is similar to the sheet illumination microscope according to example 1 except that the sheet illumination microscope according to the present example includes an illumination optical system 200 instead of the illumination optical system 100. FIG. 13A and FIG. 13B show a configuration of the illumination optical system 200 according to the present example. FIG. 13A shows a section parallel to observation optical axis AX of the illumination optical system 200 and FIG. 13B is a plan view showing a prism 230 seen from the direction of observation optical axis AX. Note that in FIG. 13A, the laser light source 11, the optical fiber 12 and the beam expander 13 are not shown.

The illumination optical system 200 is different from the illumination optical system 100 in that the illumination optical system 200 has a second optical system 210 instead of the second optical system 120. The second optical system 210 has a cylindrical lens 220 and a prism 230.

As shown in FIG. 13A and FIG. 13B, the prism 230 has a reflection surface 231 for reflecting light and a refraction surface 122 for refracting light. The reflection surface 231 is a deflector that deflects light arriving from the first optical system 110 in the direction that is perpendicular to observation optical axis AX and that is toward observation optical axis AX. The reflection surface 231 is in a three-dimensional shape that is a result of removing the central portion (portion including the vertex) of the conical surface. In other words, the reflection surface 231 has a shape that overlaps the conical surface. The reflection surface 231 is circular on its section perpendicular to observation optical axis AX and is in the shape of a line that is slanted by about 45 degrees with respect to observation optical axis AX on its section parallel to observation optical axis AX. The reflection surface 231 is similar to the reflection surface 121 in that the reflection surface 231 has a positive power on a plane perpendicular to observation optical axis AX but is different from the reflection surface 121 in that the reflection surface 231 does not have power on a plane parallel to observation optical axis AX. The refraction surface 122 is as described in example 1.

The cylindrical lens 220 is a ring-shaped cylindrical lens that has a power in the radial directions of the sectional shape formed in accordance with the sectional shape of the parallel flux emitted from the first optical system 110 and that does not have a power in the circumferential directions. The cylindrical lens 220 is one condenser for converting light arriving from the first optical system 110 into light sheets, and has a positive power on the plane that is parallel to observation optical axis AX and that includes observation optical axis AX. The positive power of the cylindrical lens 220 corresponds to the positive power that the reflection surface 121 of the second optical system 120 according to example 1 has on a plane perpendicular to observation optical axis AX.

The illumination optical system 200 having the above configuration as well can form eight light sheets having different travelling directions, as shown in FIG. 13B, with which sample S is irradiated, similarly to the illumination optical system 100. Accordingly, a sheet illumination microscope with the illumination optical system 200 as well can bring about effects similar to those brought about by the sheet illumination microscope according to example 1.

Note that the illumination optical system 200 may include, instead of the prism 230, a mirror (conical mirror) having the same shape as that of the reflection surface 231 and a concave lens array having the same negative power as that of the refraction surface 122. It is also possible to prepare a plurality of concave lens arrays, each having a different number of concave lens elements, in advance so as to use them while switching them. Thereby, the number of the light sheets can be changed.

### Example 3

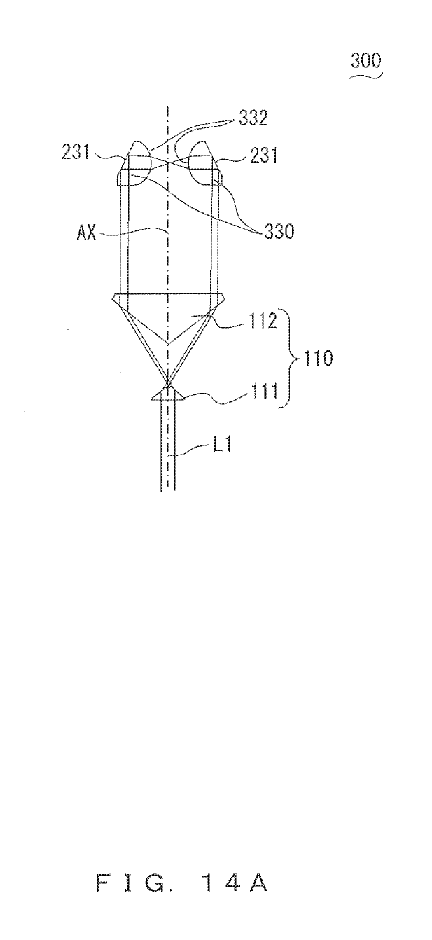

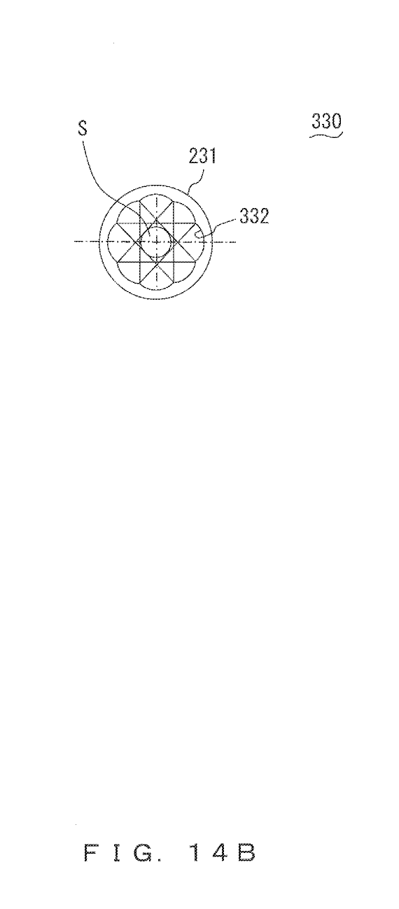

The sheet illumination microscope according to the present example is similar to the sheet illumination microscope according to example 1 except that the sheet illumination microscope according to the present example includes an illumination optical system 300 instead of the illumination optical system 100. FIG. 14A and FIG. 14B show a configuration of the illumination optical system 300 according to the present example. FIG. 14A shows a section parallel to observation optical axis AX of the illumination optical system 300 and FIG. 14B is a plan view showing a second optical system 330 as seen from the direction of observation optical axis AX. In FIG. 14A, the laser light source 11, the optical fiber 12 and the beam expander 13 are not shown.

The illumination optical system 300 is different from the illumination optical system 100 in that the illumination optical system 300 includes the second optical system 330 instead of the second optical system 120. As shown in FIG. 14A and FIG. 14B, the second optical system 330 is a prism having a reflection surface 231 for reflecting light and a refraction surface 332 for refracting light.

The refraction surface 332 is a lens surface array made of eight connected surfaces. The refraction surface 332 is similar to the refraction surface 122 in that the refraction surface 332 has a shape resulting from connecting eight arcs on a section perpendicular to observation optical axis AX. However, the refraction surface 332 is different from the refraction surface 122 in that the refraction surface 332 has a convex shape on a plane parallel to observation optical axis AX and in that it has a positive power. The reflection surface 231 is as described in example 2. Specifically, the second optical system 330 has the refraction surface 332 having a positive power that the reflection surface 121 of the second optical system 120 has on its plane parallel to observation optical axis AX. The refraction surface 332 forms light sheets on a plane perpendicular to observation optical axis AX. The refraction surface 332 functions as a condenser and functions also as a divergence element having a negative power on a plane perpendicular to observation optical axis AX.

The illumination optical system 300 having the above configuration as well can form eight light sheets having different travelling directions, as shown in FIG. 14B, with which sample S is irradiated, similarly to the illumination optical system 100. Accordingly, a sheet illumination microscope with the illumination optical system 300 also can bring about effects similar to those brought about by the sheet illumination microscope according to example 1.

Note that the illumination optical system 300 may include, instead of the second optical system 330, a mirror (conical mirror) having the same shape as that of the reflection surface 231 and a lens array having the same power as that of the refraction surface 332. It is also possible to prepare a plurality of lens arrays, each having a different number of concave lens elements, in advance so as to use them while switching them. Thereby, the number of the light sheets can be changed.

### Example 4

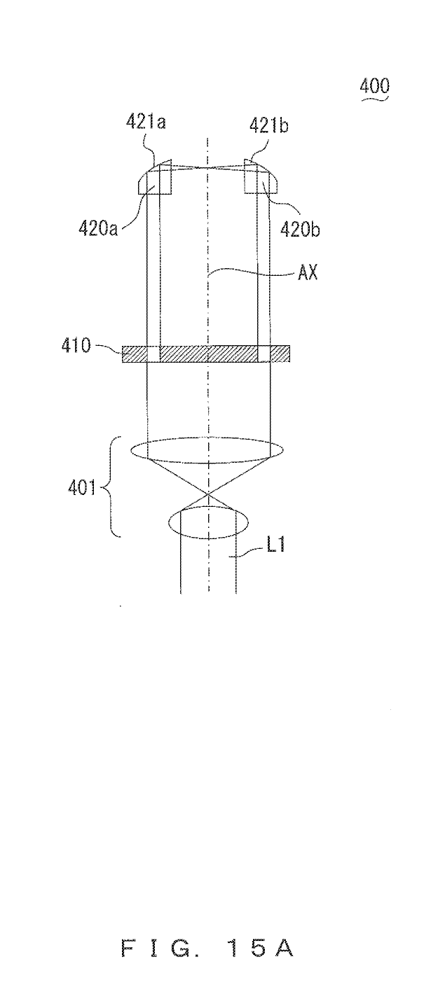

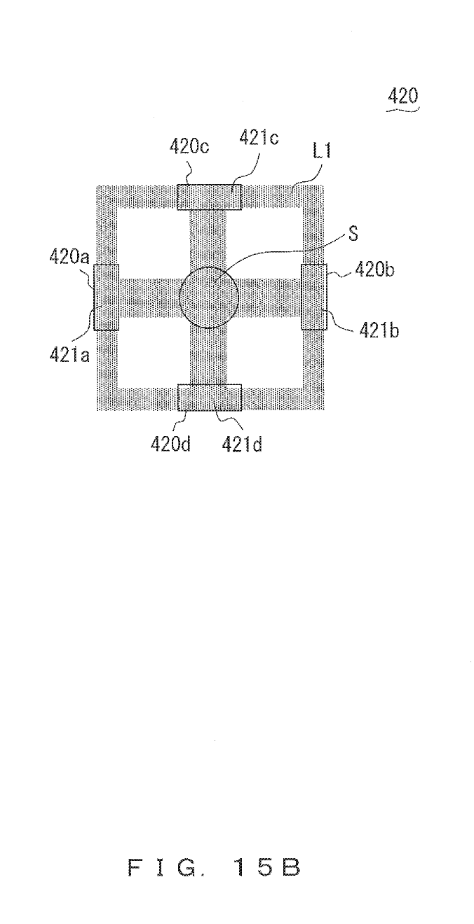

A sheet illumination microscope according to the present example is similar to the sheet illumination microscope according to example 1 except that the sheet illumination microscope according to the present example includes an illumination optical system 400 instead of the illumination optical system 100. FIG. 15A and FIG. 15B show a configuration of the illumination optical system 400 according to the present example. FIG. 15A shows a section parallel to observation optical axis AX of the illumination optical system 400 and FIG. 15B is a plan view showing a second optical system 420 seen from the direction of observation optical axis AX. In FIG. 15A, the laser light source 11 and the optical fiber 12 are not shown.

The illumination optical system 400 includes a beam expander 401, a first optical system 410, and a second optical system 420. The first optical system 410 is a light shielding plate on which an opening (or a transmission area that transmits light) in a rectangular ring shape is formed. As shown in FIG. 15A and FIG. 15B, the second optical system 420 is made of four prisms (prisms 420a, 420b, 420c and 420d) that are positioned at positions at which the parallel flux arriving from the first optical system 410 enters. The four prisms are arranged so that each of them is in a direction, around observation optical axis AX, that is 90 degrees shifted from the directions of the neighboring prisms. Each of the prisms has reflection surfaces (reflection surfaces 421a, 421b, 421c and 421d) that deflect light entering from the direction of observation optical axis AX in the direction that is perpendicular to observation optical axis AX and that is toward observation optical axis AX. Each of the reflection surfaces is linear on a section perpendicular to observation optical axis AX and is parabolic on a section parallel to observation optical axis AX (more specifically on the section that is parallel to observation optical axis AX and that includes the optical axis).

In the illumination optical system 400 having the above configuration, part of a parallel flux emitted from the beam expander 401 is transmitted through the first optical system 410 and thereby a parallel flux in a rectangular ring shape is formed. The parallel flux emitted from the first optical system 410 thereafter enters the second optical system 420 from the direction of observation optical axis AX in a state such that the center of gravity position of the sectional shape (center of the rectangular ring) of the parallel flux nearly coincides with observation optical axis AX. The parallel flux in a rectangular ring shape having entered the second optical system 420 is deflected by the four reflection surfaces (reflection surfaces 421a through 421d), which constitute a deflector, in the direction that is perpendicular to observation optical axis AX and that is toward observation optical axis AX. Upon that deflection, the parallel flux is converted by the positive power of each reflection surface, which constitutes a condenser as well, into a flux for forming light sheets on a plane perpendicular to observation optical axis AX. Thereby, four light sheets parallel to a plane perpendicular to observation optical axis AX are formed, and sample S is irradiated with these. Accordingly, a sheet illumination microscope with the illumination optical system 400 as well can bring about effects similar to those brought about by the sheet illumination microscope according to example 1.

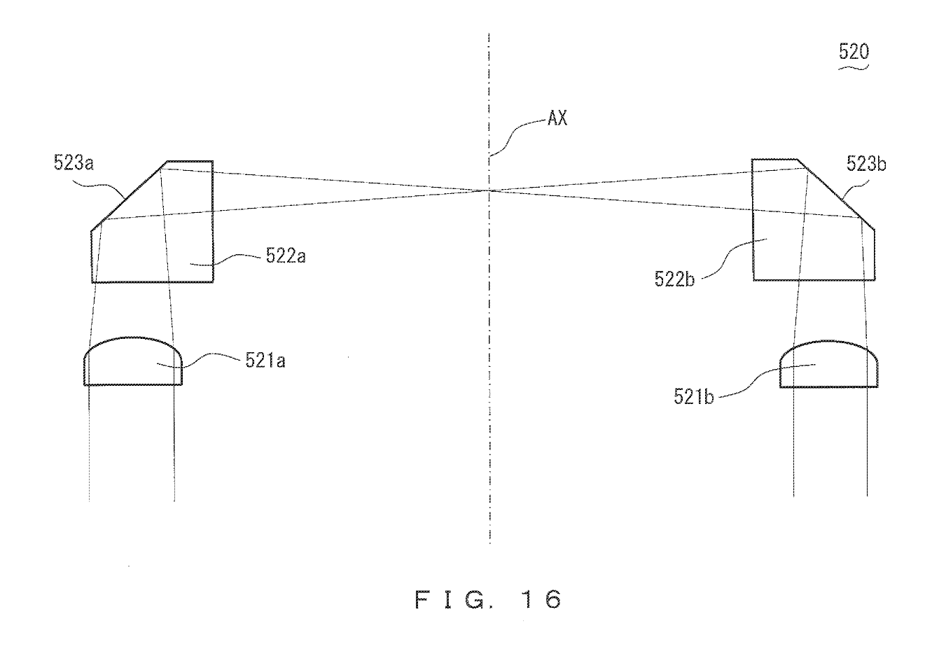

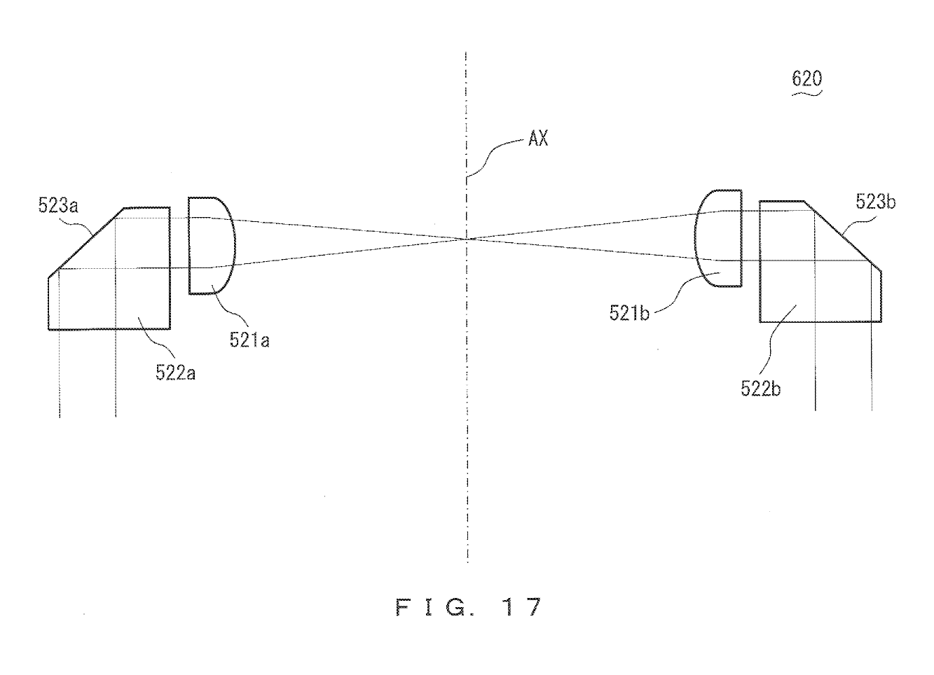

Hereinafter, by referring to FIG. 16 and FIG. 17, variation examples of the second optical system 420 of the present example will be explained. FIG. 16 shows a configuration of a second optical system 520, which is a variation example of the second optical system 420. FIG. 17 shows a configuration of a second optical system 620, which is another variation example of the second optical system 420.

The second optical system 520 is different from the second optical system 420 in that the second optical system 520 includes four cylindrical lenses (including cylindrical lenses 521a and 521b) on an optical path on the light-source side of the four prisms. Also, the second optical system 520 is different from the second optical system 420 in that four prisms (including prisms 522a and 522b), which constitute a deflector, in the second optical system 520 have reflection surfaces (including reflection surfaces 523a and 523b) having a planar shape. Each of the reflection surfaces is linear both on a section perpendicular to observation optical axis AX and a section parallel to observation optical axis AX. Similarly to the four prisms, the four cylindrical lenses are arranged at positions at which the parallel flux in a rectangular ring shape enters. In the second optical system 420, the reflection surfaces of the prisms have a positive power for condensing a parallel flux to a plane perpendicular to observation optical axis AX while in the second optical system 520, the cylindrical lenses have that positive power. The four cylindrical lenses constitute a condenser that condenses light arriving from the first optical system 410 on a plane perpendicular to observation optical axis AX so as to form light sheets.

The second optical system 620 is different from the second optical system 520 in that the second optical system 620 has the four cylindrical lenses (including cylindrical lenses 521a and 521b) arranged on an optical path on the object side of the fourth prisms (including the prisms 522a and 522b). The second optical system 620 is similar to the second optical system 520 in other aspects.

### Example 5

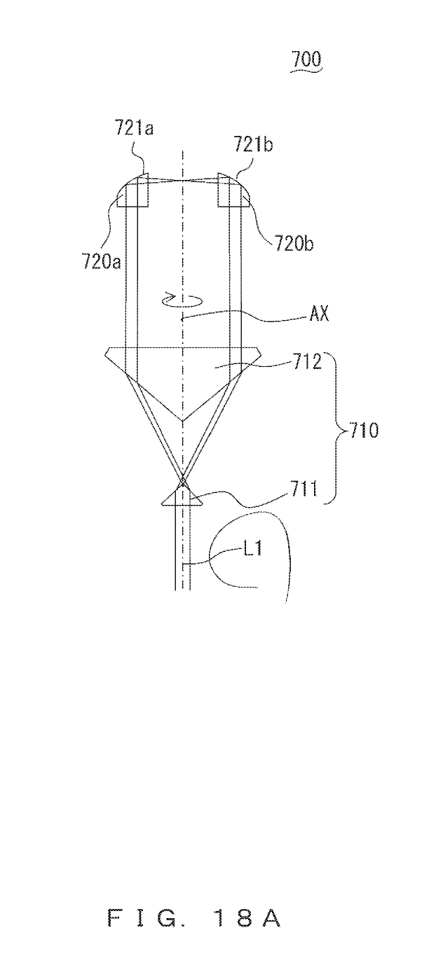

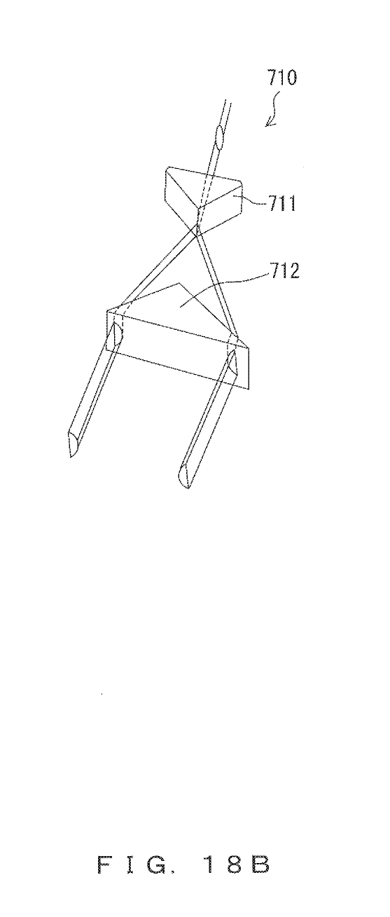

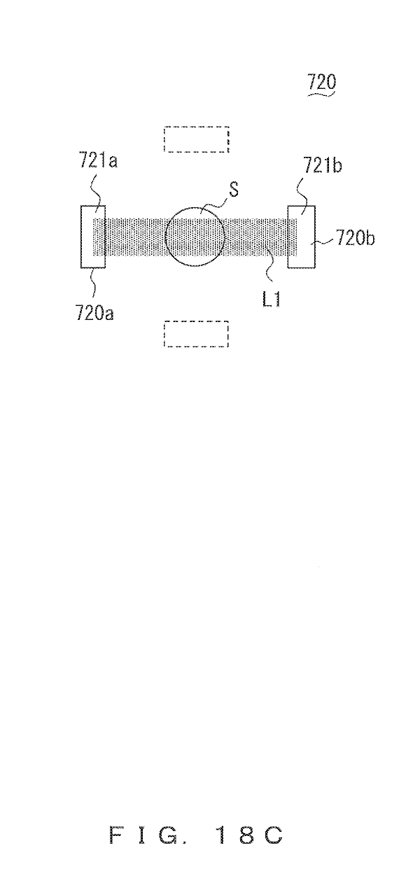

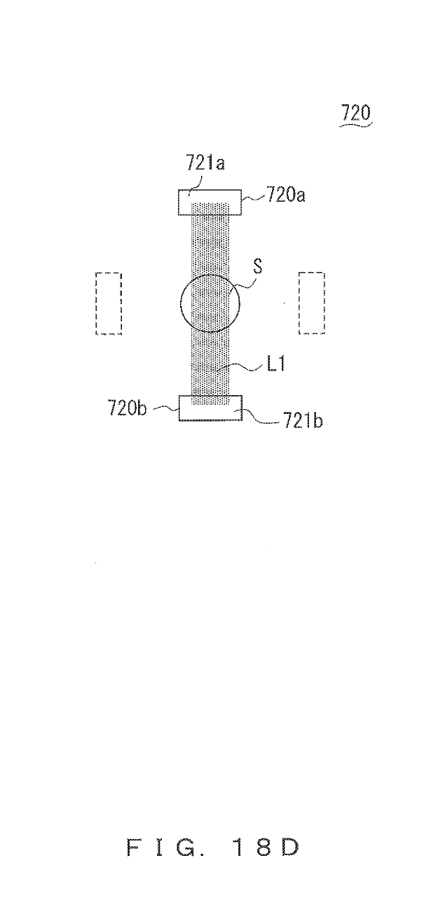

The sheet illumination microscope according to the present example is similar to the sheet illumination microscope according to example 1 except that the sheet illumination microscope according to the present example includes an illumination optical system 700 instead of the illumination optical system 100. FIG. 18A through FIG. 18D show a configuration of the illumination optical system 700 according to the present example. FIG. 18A shows a section parallel to observation optical axis AX of the illumination optical system 700, FIG. 18B is a perspective view of a first optical system 710, FIG. 18C and 18D are plan views showing a second optical system 720 before and after the revolution of the illumination optical system 700, seen from the direction of observation optical axis AX. In FIG. 18A, the laser light source 11, the optical fiber 12 and the beam expander 13 are not shown.

The illumination optical system 700 includes a first optical system 710 that forms a parallel flux having a prescribed sectional shape and a second optical system 720 that forms, from the parallel flux arriving from the first optical system 710, a plurality of light sheets having different travelling directions. The illumination optical system 700 is configured to revolve on observation optical axis AX.

As shown in FIG. 18A and FIG. 18B, the first optical system 710 includes a pair of polygonal prisms (polygonal prisms 711 and 712). The polygonal prisms 711 and 712 are arranged in line along the direction of observation optical axis AX.

As shown in FIG. 18A, FIG. 18C and FIG. 18D, the second optical system 720 includes two prisms (prisms 720a and 720b) arranged at positions at which the parallel flux from the first optical system 710 enters. The two prisms are arranged at symmetrical positions with respect to observation optical axis AX. Each of the prisms has reflection surfaces (reflection surfaces 721a and 721b) that deflect light entering from the direction of observation optical axis AX, in the direction that is perpendicular to observation optical axis AX and that is toward observation optical axis AX. Each of the reflection surfaces is linear on a plane perpendicular to observation optical axis AX and parabolic on a plane parallel to observation optical axis AX.

In the illumination optical system 700 having the above configuration, laser light L1, having a prescribed flux diameter, that has entered via the beam expander 13 (FIG. 2) is divided by the refraction in the first optical system 710 into two partial fluxes that are parallel to observation optical axis AX, and is emitted from the first optical system 710. The two partial fluxes are emitted from positions symmetrical with respect to observation optical axis AX as shown in FIG. 18A. Thus, the first optical system 710 forms a parallel flux having two partial fluxes that do not have a light intensity distribution within a prescribed range from the center of gravity of a sectional shape. The parallel flux emitted from the first optical system 710 thereafter enters the second optical system 720 from the direction of observation optical axis AX in a state such that the center of gravity position of the sectional shape of the parallel flux nearly coincides with observation optical axis AX. One of the two partial fluxes that has entered the second optical system 720 is deflected by the reflection surface 721a in the direction that is perpendicular to observation optical axis AX and that is toward observation optical axis AX, and the other partial flux is deflected by the reflection surface 721b in the direction that is perpendicular to observation optical axis AX and that is toward observation optical axis AX. Upon that deflection, the parallel flux is converted by the positive power of each reflection surface into a flux that is parallel when it is seen from the direction of observation optical axis AX and that forms a light sheet on a plane perpendicular to observation optical axis AX. Thereby, as shown in FIG. 18C, two light sheets parallel to a plane perpendicular to observation optical axis AX are formed, and sample S is irradiated with these. Further, by revolving the illumination optical system 700 on observation optical axis AX, sample S can be irradiated with two light sheets from an arbitrary direction that is perpendicular to observation optical axis AX. For example, revolving the illumination optical system 700 a plurality of times each by 90 degrees can sequentially switch between the states shown in FIG. 18C and FIG. 18D. Thus, a sheet illumination microscope including the illumination optical system 700 as well can bring about effects similar to those brought about by the sheet illumination microscope according to example 1.

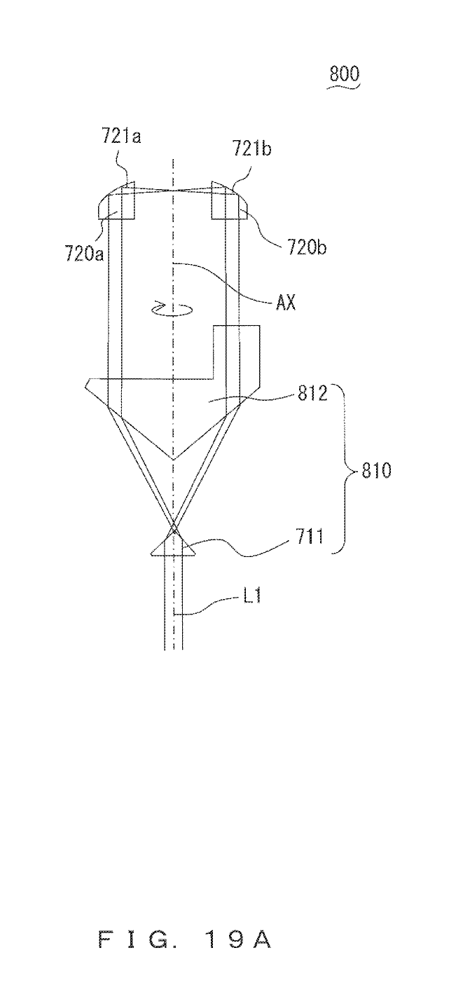

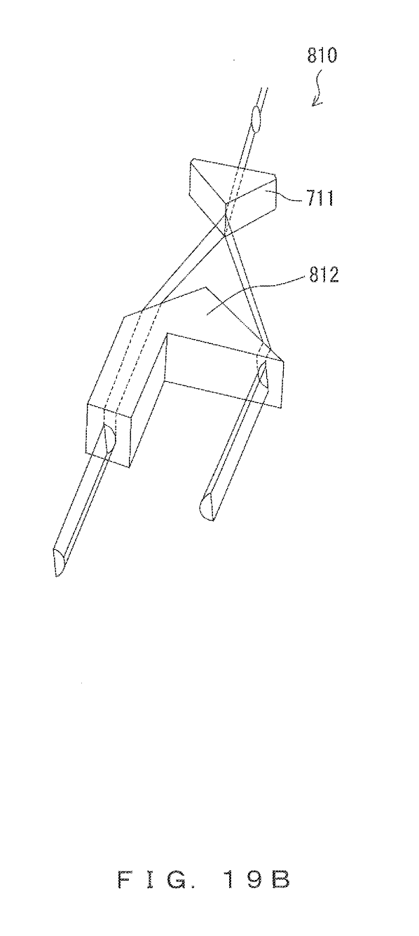

Explanations will be given for a variation example of the illumination optical system 700 according to the present example. FIG. 19A and FIG. 19B show a configuration of an illumination optical system 800, which is a variation example of the illumination optical system 700. FIG. 19A shows a section parallel to observation optical axis AX of the illumination optical system 800 and FIG. 19B is a perspective view of a first optical system 810.

The illumination optical system 800 is different from the illumination optical system 700 in that the illumination optical system 800 includes a first optical system 810 instead of the first optical system 710. The first optical system 810 includes a prism 812 instead of the polygonal prism 712. The prism 812 has a shape asymmetry with respect to observation optical axis AX so that an optical path length difference occurs between the two partial fluxes formed by a polygonal prism 811. Thus, the illumination optical system 800 can suppress interference stripes that occur due to interference between two light sheets.

The above examples are specific examples for facilitating understanding of the invention, and the present invention is not limited to these examples. The sheet illumination microscopes can allow various alterations and changes without departing from the present invention, which is defined by the claims. One example may be constituted by combining some features in the contexts of the individual examples explained in this description.

An example has been described in which the first optical system is configured of an axicon lens, a prism or an aperture, but the first optical system may be configured of for example a diffraction optical element (DOE) as long as a parallel flux not having a light intensity distribution within a prescribed range from the center of gravity position of a sectional shape is formed. Also, the first optical system may be configured of a Spatial Light Modulator (SLM) having a micro mirror device, a liquid crystal device, etc. It is also possible to employ a configuration in which a shutter that shields part of a parallel flux formed by the first optical system is provided so that operations of the shutter form a parallel flux in an arbitrary shape in accordance with the shape of the deflector.

An example has been described in which an optical path length difference is provided for suppressing interference stripes that occur due to coherence of laser light, but interference stripes may be suppressed by a different method. For example, a device for vibrating the optical fiber 12 may be provided. Also, an optical stirrer to which laser light enters or a frequency modulator for modulating the frequency of laser light may be provided. These configurations as well can reduce a coherence of laser light so as to suppress interference stripes.

Also, an example has been described in which the parallel flux consists of two partial fluxes, but the parallel flux may consist of three or more partial fluxes. In such a case, it is desirable that the three or more partial fluxes be arranged in a circular shape or a polygonal shape. When the three or more partial fluxes are arranged in a polygonal shape, the second optical system may include a refraction surface that is a condenser for forming a light sheet on a plane perpendicular to observation optical axis AX and a planar reflection surface that is a deflector. Alternatively, a reflection surface, functioning as both a deflector and a condenser, that has a parabolic shape on a plane parallel to observation optical axis AX may be provided. When the three or more partial fluxes are arranged in a circular shape, it is desired that the second optical system be provided with a reflection surface, functioning as both a deflector and a condenser, that has a shape overlapping the paraboloid of revolution, and a refraction surface, functioning as a divergence element, that has a negative power on a plane perpendicular to observation optical axis AX. Alternatively, a refraction surface, functioning as a condenser, that condenses light to a plane perpendicular to observation optical axis AX, a reflection surface, functioning as a deflector, that has a shape overlapping the conical surface, and a refraction surface, functioning as a divergence element, that has a negative power on a plane perpendicular to observation optical axis AX may be provided. In such a case, the refraction surface functioning as a condenser and the refraction surface functioning as a divergence element may be the same surface.

Also, when sample S is irradiated with light sheets with sample S contained in a container, a side surface of the container may refract light sheets. Accordingly, it is desirable that a container containing sample S be in such a shape that a plurality of light sheets enters orthogonally to the side surface. For example, when light sheets enter from eight directions as shown in FIG. 4, it is desirable that the container be in an octagonal shape when it is seen from the direction of observation optical axis AX. This can prevent the refraction of light sheets in the container.

Further, the container may constitute the second optical system. In other words, a side surface of the container may function as for example the refraction surface 122, having a negative power on a plane perpendicular to observation optical axis AX, of the prism shown in FIG. 9A and FIG. 9B.

Alternatively, it may function as the refraction surface 332, having a positive power that condenses light to a plane perpendicular to observation optical axis AX and that has a negative power on a plane perpendicular to observation optical axis AX, of the prism shown in FIG. 14A and FIG. 14B.

1. A sheet illumination microscope comprising:
an observation optical system configured to form an image of a sample by utilizing light from the sample; and
an illumination optical system configured to illuminate the sample from a direction perpendicular to an observation optical axis of the observation optical system,
wherein the illumination optical system includes:
a first optical system configured to emit a flux that has a prescribed sectional shape and that does not have a light intensity distribution within a prescribed range from a center of gravity position of the sectional shape; and
a second optical system that includes a deflector and that is configured to form, from the flux, a plurality of light sheets that are parallel to a plane perpendicular to the observation optical axis and that have different traveling directions, the deflector being configured to deflect, toward the observation optical axis, light entering from the first optical system.

2. The sheet illumination microscope according to claim 1, wherein the second optical system is configured to form the plurality of light sheets each of which is a nearly parallel flux on a plane that is perpendicular to the observation optical axis.

3. The sheet illumination microscope according to claim 2, wherein the second optical system is configured to form the plurality of light sheets each of which is a convergent flux on a plane that includes the observation optical axis and an optical axis of illumination light of the light sheet.

4. The sheet illumination microscope according to claim 3, wherein the second optical system is configured so that the plurality of light sheets condense light at different positions.

5. The sheet illumination microscope according to claim 1, wherein the first optical system is configured to emit the flux that has the center of gravity position nearly coinciding with the observation optical axis.

6. The sheet illumination microscope according to claim 1, wherein the first optical system is configured to emit the flux in a looped shape.

7. The sheet illumination microscope according to claim 6, wherein:
the first optical system is configured to emit the flux in a ring shape,
the deflector is a reflection surface in a shape that overlaps a paraboloid of revolution, and
the second optical system further includes a divergence element having a negative power on a plane that is perpendicular to the observation optical axis.

8. The sheet illumination microscope according to claim 6, wherein:
the first optical system is configured to emit the flux in a ring shape,
the deflector is a reflection surface in a shape that overlaps a conical surface, and
the second optical system further includes a divergence element having a negative power on a plane that is perpendicular to the observation optical axis.

9. The sheet illumination microscope according to claim 6, wherein:
the first optical system is configured to emit the flux in a polygonal ring shape, and
the deflector is a reflection surface that has a parabolic shape on a section parallel to the observation optical axis.

10. The sheet illumination microscope according to claim 6, wherein:
the first optical system is configured to emit the flux in a polygonal ring shape, and
the deflector is a reflection surface that has a planar shape.

11. The sheet illumination microscope according to claim 1, wherein the first optical system is configured to emit the flux consisting of a plurality of partial fluxes.

12. The sheet illumination microscope according to claim 11, wherein:
the first optical system is configured to emit the flux consisting of the plurality of partial fluxes, wherein plurality of partial fluxes are arranged in a circular shape,
the deflector is a reflection surface in a shape that overlaps a paraboloid of revolution, and
the second optical system further includes a divergence element that has a negative power on a plane perpendicular to the observation optical axis.

13. The sheet illumination microscope according to claim 11, wherein:
the first optical system is configured to emit the flux consisting of the plurality of partial fluxes, wherein plurality of partial fluxes are arranged in a circular shape,
the deflector is a reflection surface in a shape that overlaps a conical surface, and
the second optical system further includes a divergence element that has a negative power on a plane perpendicular to the observation optical axis.

14. The sheet illumination microscope according to claim 11, wherein:
the first optical system is configured to emit the flux consisting of the plurality of partial fluxes, wherein the plurality of partial fluxes are arranged in a polygonal shape, and
the deflector is a reflection surface having a parabolic shape on a section parallel to the observation optical axis.

15. The sheet illumination microscope according to claim 11, wherein:
the first optical system is configured to emit the flux consisting of the plurality of partial fluxes, wherein the plurality of partial fluxes are arranged in a polygonal shape, and
the deflector is a reflection surface having a planar shape.

16. The sheet illumination microscope according to claim 1, wherein:
the first and second optical systems constitute a single illumination module, and
the illumination module is configured to move in the direction of the observation optical axis in coordination with a position of an objective included in the observation optical system.

17. The sheet illumination microscope according to claim 1, wherein the second optical system is configured:
to be attachable to and detachable from an objective included in the observation optical system, and
to move in the direction of the observation optical axis in coordination with a position of the objective.

18. The sheet illumination microscope according to claim 1, wherein the second optical system is configured to be attachable to and detachable from the first optical system.

19. The sheet illumination microscope according to claim 1, wherein the second optical system is configured to form at least three light sheets having different traveling directions.

20. An illumination method for a sheet illumination microscope that illuminates a sample from a direction perpendicular to an observation optical axis of an observation optical system, the illumination method comprising:
emitting a flux that has a prescribed sectional shape and that does not have a light intensity distribution within a prescribed range from a center of gravity position of the sectional shape; and
deflecting light traveling in a direction parallel to the observation optical axis so as to form, from the flux, a plurality of light sheets that are parallel to a plane perpendicular to the observation optical axis and that have different traveling directions.
